(19) United States
(12) Patent Application Publication
(10) Pub. No.: US 2020/0400488 A1
(43) Pub. Date: Dec. 24, 2020

(54) SCALE TRAY

(71) Applicant: SICK AG, Waldkirch (DE)

(72) Inventors: Kai BUDERER, Waldkirch (DE); Simon UHL, Waldkirch (DE); Philipp POELLING, Waldkirch (DE)

(21) Appl. No.: 16/903,087

(22) Filed: Jun. 16, 2020

(30) Foreign Application Priority Data
Jun. 18, 2019 (DE) 102019116508.3

(51) Int. Cl. G01G 21/22; G02B 27/28; G03B 11/00; G03B 15/03; G01G 19/00; G06T 7/70; H04N 5/225

(52) U.S. Cl. CPC G01G 21/22; G02B 27/286; G03B 11/00; G03B 15/03; G01G 19/007; G06T 2207/30242; H04N 5/2256; H04N 5/2253; H04N 5/2254; G03B 2215/0575; G03B 2215/0592; G06T 7/70

(57) ABSTRACT

A picking system, a camera system, and a scale tray for a precision scale, wherein the base of the scale tray has a bright material so that the base forms a bright background for parts placed in the scale tray and wherein the base of the scale tray forms a reflector, with the reflector rotating reflected polarized light in the polarization direction with respect to incident polarized light.

The present invention relates to a scale tray scale tray for a precision scale, to a camera system for a precision scale having a camera with a field of view and a scale tray, and to a picking system using a camera system and a picking scale for weighing a plurality of parts,.

In order to package small parts, for example small metal parts that are packed as loose goods in a single sort, a number of pieces should be exactly determined. For this purpose, users in businesses use two different scales at picking stations.

A first rough scale for determining the filling amount or number of pieces that the packaging unit or container for end customers should have. A second precision scale is furthermore used for weighing fewer parts. The picking person places a known number of small parts of an article on this precision scale, that can only receive a small maximum load, and determines their weight, e.g. 30 g for a number of 10 parts.

With knowledge of this division ratio, according to which e.g. a single part weights 3 g, the packaging unit or the container is now filled up to the calculated number of pieces on the rough scale. If the picking person has miscounted, incorrect filling amounts occur in the packaging units.

Image processing systems that should determine the number of the parts placed on the precision scale are used to assist the picking person. Together with the weight information from the precision scale, the rough scale should be set automatically or the number of the parts on the precision scale should be determined automatically.

To be able to count individual parts of different appearance as reliably as possible with a camera or an image processing system, lighting should ideally be by transmitted light so that the camera or the image processing system can recognize the individual parts by the generated dark shadow areas that result from the type of illumination and reflections at the surfaces of the individual parts such as can arise with the incident light process are avoided. So-called light panels, usually on an LED basis, are used as standard for transmitted light illumination and require an external voltage supply.

If such an illumination device for transmitted light illumination is placed on a precision scale to determine the weight of the illumination device, the difficulty arises that a cable connection to an external power supply that is not located on the scale has to be made, which falsifies the weighing process.

An alternative autonomous voltage supply of the illumination device by rechargeable batteries that would then likewise be located on the precision scale results in high total weights that are outside the measurement range of the precision scale.

An object of the invention is to provide a simply controllable, light, and inexpensive device for a camera detection of loose parts on a precision scale.

The object is satisfied by a scale tray for a precision scale, wherein the base of the scale tray has a bright material so that the base forms a bright background for parts placed in the scale tray, with the base of the scale tray forming a reflector, and with the reflector rotating reflected polarized light in the polarization direction with respect to incident polarized light.

For example, the reflected polarized light is changed with respect to incident polarized light by 90° in the polarization direction or in the polarization oscillation direction.

The object is further satisfied by a camera system for a precision scale having a camera with a field of view, having a scale tray, wherein the field of view of the camera is directed to the scale tray, wherein the camera has a first polarization filter, wherein an illumination unit is arranged, wherein the illumination unit is directed to the scale tray, wherein the illumination unit has a second polarization filter, wherein the first polarization filter has a first polarization direction and the second polarization filter has a second polarization direction, and wherein the polarization direction of the first polarization filter and the polarization direction of the second polarization filter are offset or rotated with respect to one another.

For example, the polarization direction of the first polarization filter and the polarization direction of the second polarization filter are offset or rotated by 90° with respect to one another.

The object is further satisfied by a picking system using a camera system and a picking scale for weighing a plurality of parts, wherein the weighing process of the picking scale is based on a detected weight of at least one part of the precision scale.

The invention utilizes the light property of polarization. If the polarized light of the illumination unit is incident on a reflective surface of the parts in the scale tray to be determined, the oscillation direction of the light is not changed. The reflected light cannot pass through the first polarization filter in front of the camera. The reflective surface of the parts to be detected appears as dark in the camera image.

The polarized light that is, however, reflected from the base of the scale tray is rotated, for example by 90°, in the polarization direction with respect to the incident light so that this light can pass through the first polarization filter in front of the camera. The base of the scale tray thereby appears as bright in the camera image.

The illumination unit can be formed and arranged differently. The illumination unit is, however, preferably arranged very close to the objective to avoid shadow formation.

In a further development of the invention, the base of the scale tray has a multilayer structure that comprises at least three layers.

A first, bottommost layer of the base forms a support material. The support material can be formed of acrylic glass, for example. The thickness of the support material amounts, for example, to 2 mm to 5 mm, in particular to approximately 3 mm. The support material forms the mechanically stable layer for the scale tray.

A second layer that is arranged on the first layer, the support material, is a layer having a reflective film. It is, for example, a reflective film of the type REF-7610-K. This layer has the optical result that the illumination light is reflected back with an efficiency that is as high as possible at the points at which no parts to be weighed are located.

A third layer, that is arranged on the second layer, is a transparent film, for example a polypropylene film. The third layer can also comprise a plurality of transparent films. This layer produces a better contrast ratio or a contrast increase. The film is preferably a permanent and grained film.

The at least three layers can be formed by separate materials. However, provision can also be made that the three layers are formed as a single-piece composite material.

In a further development of the invention, the scale tray has a weight of less than 500 g, in particular less than 400 g. The scale tray can thereby be placed on precision scales without restricting the effective weighing range.

In a further development of the invention, the precision scale has a weighing range from 0.001 g to 6000 g. Such precision scales are designed for industrial use and have a weighing area of, for example, approximately 100 mm×100 mm up to 300 mm×300 mm.

In a further development of the invention, the polarization filters are linear polarization filters. Such polarization filters are available at a favorable price. However, circular polarization filters can also be used.

In a further development of the invention, the illumination unit is a ring lighting unit that is arranged around the camera. Shadow formation is thereby prevented since the illumination is arranged around the camera and results in uniform illumination.

The invention will also be explained in the following with respect to further advantages and features with reference to the enclosed drawing and to embodiments. The Figures of the drawing show in:

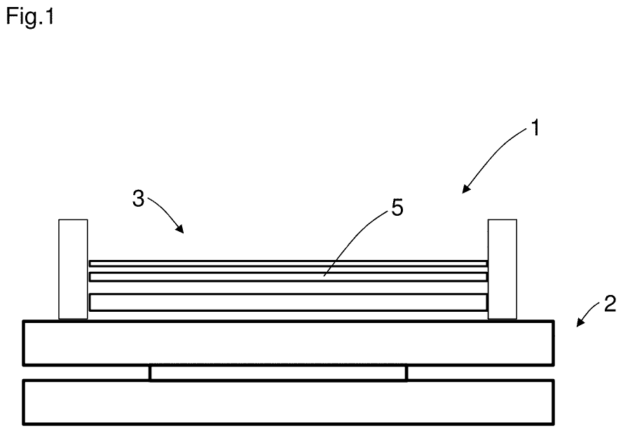

FIG. 1 a scale tray on a precision scale;

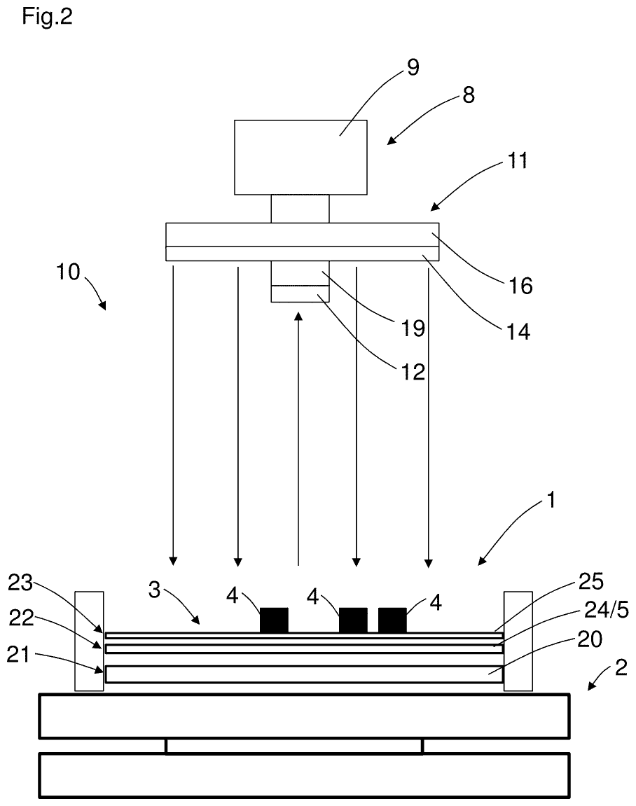

FIG. 2 a camera system having a scale tray on a precision scale;

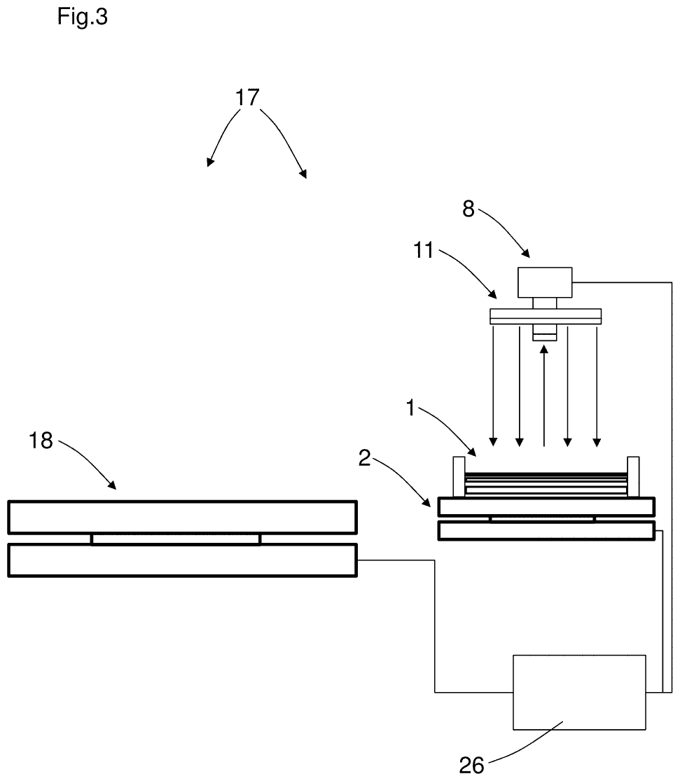

FIG. 3 a picking system having a camera system; and

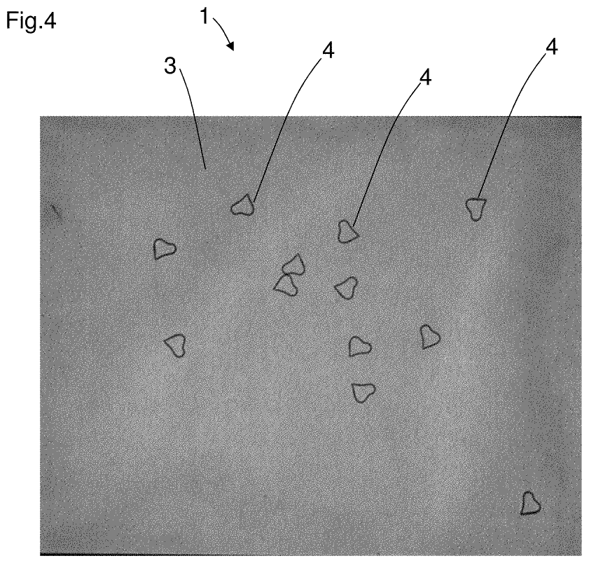

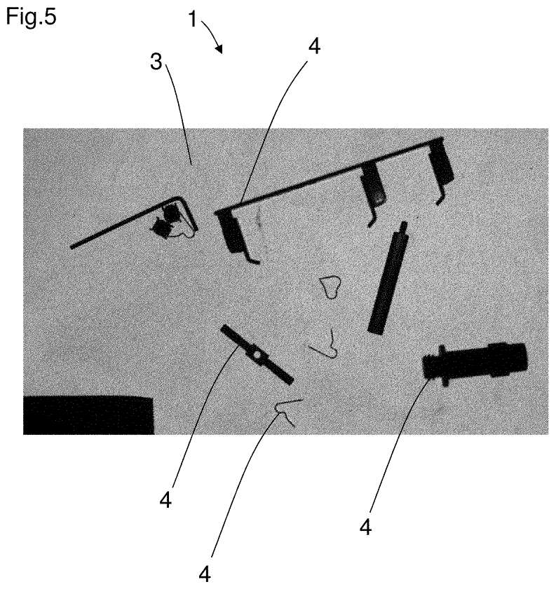

FIGS. 4 and 5 in each case parts on a scale tray.

In the following Figures, identical parts are provided with identical reference numerals.

FIG. 1 shows a scale tray 1 for a precision scale 2, wherein the base 3 of the scale tray 1 has a bright material so that the base 3 forms a bright background for parts placed in the scale tray, with the base 3 of the scale tray 1 forming a reflector 5, and with the reflector 5 rotating reflected polarized light in the polarization direction with respect to incident polarized light.

For example, reflected polarized light is rotated by 90° in the polarization direction or in the polarization oscillation direction with respect to incident polarized light.

FIG. 2 shows the precision scale 2 having a camera 9 with a field of view 10, having a scale tray 1, wherein the field of view 10 of the camera 9 is directed to the scale tray 1, wherein the camera 9 has a first polarization filter 12, wherein an illumination unit 11 is arranged, wherein the illumination unit 11 is directed to the scale tray 1, wherein the illumination unit 11 has a second polarization filter 14, wherein the first polarization filter 12 has a first polarization direction and the second polarization filter 14 has a second polarization direction, and wherein the polarization direction of the first polarization filter 12 and the polarization direction of the second polarization filter 14 are offset or rotated with respect to one another.

For example, the polarization direction of the first polarization filter 12 and the polarization direction of the second polarization filter 14 are offset by 90° with respect to one another.

If, in accordance with FIG. 2, the polarized light of the illumination unit 11 is incident on a reflective surface of the parts 4 in the scale tray 1 to be determined, the oscillation direction of the light is not changed. The reflected light cannot pass through the first polarization filter 12 in front of the camera 9. The reflective surface of the parts 4 to be detected appears as dark in the camera image, as shown by way of example in FIG. 4 and FIG. 5.

The polarized light that is, however, reflected from the base 3 of the scale tray 1 is rotated, for example by 90°, in the polarization direction with respect to the incident light so that this light can pass through the first polarization filter 12 in front of the camera 9. The base 3 of the scale tray 1 thereby appears as bright in the camera image, as shown by way of example in FIG. 4 and FIG. 5.

The illumination unit 11 can be formed and arranged differently. The illumination unit 11 is, however, preferably arranged very close to the objective 19.

The base 3 of the scale tray 1 has a multilayer structure that comprises at least three layers.

A first, bottommost layer 21 of the base forms a support material 20. The support material 20 can be formed of acrylic glass, for example. The support material 20 forms the mechanically stable layer for the scale tray 1.

A second layer 22 that is arranged on the first layer 21, the support material 20, is a layer having a reflective film 24 or a reflector 5. This second layer 22 has the optical result that the illumination light is reflected back with an efficiency that is as high as possible at the points at which no parts 4 to be weighed are located.

A third layer 23, that is arranged on the second layer 22, is a transparent film 25, for example a polypropylene film. The third layer 23 can also comprise a plurality of transparent films 25

For example, the scale tray 1 has a weight of less than 500 g, in particular less than 400 g. The scale tray 1 can thereby be placed on precision scales 2 without restricting the effective weighing range.

The polarization filters 12 and 14 are linear polarization filters, for example. However, circular polarization filters can also be used.

In accordance with FIG. 2, the illumination unit 11 is a ring illumination unit 16 that is arranged around the camera 9. Shadow formation is thereby prevented since the illumination is arranged around the camera 9 and results in uniform illumination.

FIG. 3 shows a picking system 17 using a camera system 8 and using a picking scale 18 for weighing a plurality of parts, wherein the weighing process of the picking scale 18 is based on a detected weight of at least one weighing part of the precision scale 2. The camera system 8 having the illumination unit 11, the precision scale 2, and the picking scale 18 are here connected to a control and evaluation unit 26.

### REFERENCE NUMERALS

1 scale tray

2 precision scale

3 base of the precision scale

4 part, parts

5 reflector

8 camera system

9 camera

10 field of view

11 illumination unit

12 first polarization filter

14 second polarization filter

16 ring illumination unit

17 picking system

18 picking scale

19 objective

20 support material

21 first layer

22 second layer

23 third layer

24 reflective film

25 transparent film

26 control and evaluation unit

1. A scale tray for a precision scale,
wherein a base of the scale tray has a bright material so that the base forms a bright background for parts placed in the scale tray, with
the base of the scale tray forming a reflector, with the reflector rotating reflected polarized light in the polarization direction with respect to incident polarized light.

2. The scale tray in accordance with claim 1, wherein the base of the scale tray has a multilayer structure that comprises at least three layers.

3. The scale tray in accordance with claim 1, wherein the scale tray has a weight of less than 500 g.

4. The scale tray in accordance with claim 3, wherein the scale tray has a weight of less than 400 g.

5. The scale tray in accordance with claim 1, wherein the precision scale has a weighing range of 0.001 to 6000 g.

6. A camera system for a precision scale having a camera with a field of view, having a scale tray, wherein a base of the scale tray has a bright material so that the base forms a bright background for parts placed in the scale tray, with the base of the scale tray forming a reflector, with the reflector rotating reflected polarized light in the polarization direction with respect to incident polarized light, wherein a field of view of the camera is directed to the scale tray; wherein the camera has a first polarization filter; the camera further comprising an illumination unit; wherein the illumination unit is directed to the scale tray; wherein the illumination unit has a second polarization filter; wherein the first polarization filter has a first polarization direction and the second polarization filter has a second polarization direction; and wherein the polarization direction of the first polarization filter and the polarization direction of the second polarization filter are rotated with respect to one another.

7. The camera system in accordance with claim 6, wherein the polarization filters are linear polarization filters.

8. The camera system in accordance with claim 6, wherein the illumination unit is a ring illumination unit that is arranged around the camera.

9. A picking system using a camera system for a precision scale and using a picking scale for weighing a plurality of parts, wherein the camera system has a camera with a field of view, having a scale tray, wherein a base of the scale tray has a bright material so that the base forms a bright background for parts placed in the scale tray, with the base of the scale tray forming a reflector, with the reflector rotating reflected polarized light in the polarization direction with respect to incident polarized light, wherein a field of view of the camera is directed to the scale tray; wherein the camera has a first polarization filter; the camera further comprising an illumination unit; wherein the illumination unit is directed to the scale tray; wherein the illumination unit has a second polarization filter; wherein the first polarization filter has a first polarization direction and the second polarization filter has a second polarization direction; and wherein the polarization direction of the first polarization filter and the polarization direction of the second polarization filter are rotated with respect to one another, and wherein the weighing process of the picking scale is based on a detected weight of at least one part of the precision scale.
